(19) United States
(12) Patent Application Publication
(10) Pub. No.: US 2003/0223323 A1
(43) Pub. Date: Dec. 4, 2003

(54) Ejecting device

(75) Inventor: Hiroshi Osawa, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/421,694

(22) Filed: Apr. 24, 2003

(30) Foreign Application Priority Data
May 28, 2002 (JP) P2002-154356

(51) Int. Cl. G11B 7/085

(52) U.S. Cl. 369/30.36

(57) ABSTRACT

An ejecting device of an optical disk apparatus measures the time from timing when chucking is canceled until timing when a tray is ejected from the main body by a predetermined amount, and determines timing for applying a brake by using the measured time. Consequently, the tray can be always ejected by an appropriate amount without being affected by the magnitude of the load during the movement of the tray and without being affected by the change over time of the main body of the apparatus.

The present disclosure relates to the subject matter contained in Japanese Patent Application No. 2002-154356 filed May 28, 2002, which is incorporated herein by reference in its entirety.

### BACKGROUND OF THE INVENTION

1. Field of the Invention

The present invention relates to an ejecting device for ejecting a disk such as a CD or a DVD, which is set in a main body, by moving a tray for mounting the disk thereon.

2. Description of the Related Art

Reproducing apparatuses for reading and reproducing data recorded on an optical disk such as a CD or a DVD as well as recording apparatuses for recording data input to the optical disk are conventionally known. Hereafter, the reproducing apparatuses and recording apparatuses will be referred to as optical disk apparatuses. A tray provided in a general optical disk apparatus is so constructed as to be movable between a set position for setting the mounted optical disk in a main body of the optical disk apparatus and an eject position for ejecting the optical disk from the main body. When the tray is in the set position, the tray is accommodated in the main body, and when in the eject position, the tray is in a state in which it has been pulled out from the main body.

In addition, the optical disk apparatus has a mechanism portion for holding (chucking) the optical disk onto a turntable in a state in which the optical disk set in the main body is lifted off the tray. In a general optical disk apparatus, the turntable disposed below the tray is raised during chucking so as to lift the optical disk mounted on the tray (lift the optical disk off the tray). A projecting portion which fits in a central hole of the optical disk is formed on the turntable. A disk damper fitted to a chucking plate is disposed above the turntable. The disk damper is formed of a magnet. The turntable is formed of either iron or a magnet. As the turntable is raised, the turntable and the disk damper are adsorbed to each other with the optical disk clamped therebetween, thereby chucking the optical disk. The turntable is attached to a rotating shaft of a spindle motor, and is rotated by the spindle motor. As the turntable is rotated, the chucked optical disk is rotated.

When the tray is in the set position and an ejection switch provided on the main body is operated, the optical disk apparatus cancels chucking, and then moves the tray from the set position to the eject position. The cancellation of chucking is a process in which the state of absorption between the turntable and the disk damper is canceled by lowering the turntable, so as to return to the state in which the optical disk is mounted on the tray (the state in which optical disk is not lifted off the tray). In the general optical disk apparatus, the driving force for lowering the turntable during the cancellation of chucking and the driving force for moving the tray in the ejecting direction after the cancellation of chucking are generated by one motor (dc motor). Gears for transmitting the torque of this motor are arranged to be changed over between the time of the cancellation of chucking and the time after the cancellation of chucking.

In addition, the optical disk apparatus is provided with a switch which is turned on when the tray has been ejected by a predetermined amount. Upon detecting that the tray has been ejected by a predetermined amount by means of this switch, the optical disk apparatus stops the movement of the tray by applying a brake to the dc motor after the lapse of a predetermined time.

FIG. 9 shows the voltage to be applied to the dc motor during the movement of the tray from the set position to the eject position described above (during ejection). In FIG. 9, t11 denotes a timing when the eject switch provided on the main body is operated. At this timing the optical disk apparatus first effects the cancellation of chucking. In the cancellation of chucking, since the turntable is lowered against the magnetic force, the load applied to the dc motor is large in comparison with the load occurring during the movement of the tray after the cancellation of chucking which will be described later. A preset chucking cancellation voltage v1 is applied to the dc motor. The driving force of the dc motor acts in the direction in which the turntable is lowered through the gears. Upon detecting the cancellation of chucking at the timing t12, the optical disk apparatus changes over the voltage to be applied to the dc motor from the chucking cancellation voltage v1 to a holding voltage v2 lower than that voltage. This holding voltage v2 is also preset.

Upon cancellation of chucking, the gears are changed over, so that the driving force of the dc motor changes from the direction for lowering the turntable to the direction for moving the tray in the ejecting direction. Upon detecting that the tray has been ejected from the main body by a predetermined amount at timing t13, the optical disk apparatus stops the movement of the tray by applying a brake after waiting for a predetermined time. Timing t14 shown in FIG. 9 is the timing applying the brake.

The conventional optical disk apparatus applies the brake after waiting for a fixed time subsequent to detecting that the tray has been ejected by a predetermined amount from the main body, as described above. Meanwhile, the amount of movement whereby the tray moves in the ejecting direction from the timing t13 when the tray has been ejected from the main body by a predetermined amount until the timing t14 when the brake is applied differs depending on the variation of the load applied to the motor. The variation of the load referred to here occurs due to various factors including the weight of the tray, the meshing of the gears, friction between the tray and the main body, and so on. Also, the aforementioned amount of movement differs depending on the variation of the torque of the dc motor with respect to the voltage applied thereto (variation of the dc motor).

For this reason, in the case of the tray whose load applied to the dc motor is large, the tray is stopped short of the eject position, so that the user must pull out the tray to the eject position to remove the optical disk mounted on the tray or set the optical disk on the tray. Hence, there is a problem in that the replacement of the optical disk is troublesome. On the other hand, in a case where the load is small, the tray collides hard against stoppers provided on the main body to prevent the tray from being drawn out from the main body. Hence, there are problems in that the optical disk jumping out from the tray owing to the impact at that time becomes broken, and that the main body itself, including the stoppers, is damaged.

It should be noted that proposals have already been made concerning a device for varying the ejecting speed of the tray in correspondence with the pressing pressure of the ejection switch or the pressing time thereof (JP-A-9-139002), a device allowing the user to freely set the ejecting speed of the tray (JP-A-9-259499), and a device for gradually reducing the ejecting speed of the tray (JP-A-10-106111). However, none of these devices is designed to over come the aforementioned problems.

### SUMMARY OF THE INVENTION

An object of the invention is to provide an ejecting device which improves the reliability of a main body of an apparatus by suppressing the variation of the amount of ejection of a tray during ejection.

To solve the above-described problems, an ejecting device in accordance with the invention is provided with the following construction.

An ejecting device including a main body; a tray on which a disk to be set in the main body is mounted; a tray moving section for moving the tray between a set position for setting the disk in the main body and an eject position for ejecting the disk from the main body; a detecting section for detecting that the tray is ejected from the main body by a predetermined amount during the movement of the tray from the set position to the eject position; and a controlling section for determining a timing for stopping the movement of the tray by the tray moving section on the basis of the time from the start of ejection of the tray until the ejection of the tray by the predetermined amount.

In this construction, the detecting section detects that the tray has been ejected from the set position by a predetermined amount. The controlling section measures the time required for the tray with the optical disk mounted thereon to be ejected from the set position by a predetermined amount, and determines the timing for stopping the movement of the tray on the basis of that time.

The smaller the load during the movement of the tray, the shorter the time required for the tray to be ejected from the set position by a predetermined amount. On the other hand, the greater the load, the longer the time required for the tray to be ejected from the set position by a predetermined amount. Accordingly, the magnitude of the load during the movement of the tray can be determined from the time required for the tray to be ejected from the set position by a predetermined amount. As a result, since the tray can be stopped in correspondence with the magnitude of the load during the movement of the tray, the amount of ejection of the tray can be fixed without being affected by the variation of the load during the movement of the tray. In addition, the amount of ejection of the tray can be fixed without being affected by a change over time.

The timing for stopping the movement of the tray is, for instance, a timing for applying a brake.

In addition, the stopping of the tray can be stabilized by gradually reducing the moving speed of the tray during a period from the time the tray is ejected from the main body by a predetermined amount until the brake is applied.

Further, the magnitude of a force in a moving direction to be applied to the tray during the time from the start of ejection of the tray until the ejection of the tray by the predetermined amount at the time of an ensuing ejection of the tray may be controlled on the basis of the time required from the start of ejection of the tray until the ejection of the tray by the predetermined amount as well as the magnitude of the force in the moving direction applied to the tray when the tray is moved from the set position to the eject position.

If this arrangement is provided, the time required for the tray to be ejected from the main body by the predetermined amount can be fixed, and the variation of the time involved in the ejection of the tray can be eliminated.

### BRIEF DESCRIPTION OF THE DRAWINGS

FIG. 1A is a schematic diagram of an optical disk apparatus in accordance with an embodiment of the invention;

FIG. 1B is a schematic side view of a mechanism for raising a turntable in the optical disk apparatus;

FIG. 2 is a diagram illustrating a reverse surface of a tray used in the optical disk apparatus;

FIG. 3 is a plan view illustrating the interior of the optical disk apparatus;

FIG. 4A is a front elevational view of a chucking canceling member;

FIG. 4B is a rear view of the chucking canceling member;

FIG. 5 is a diagram illustrating the configuration of a movement controlling mechanism for controlling the movement of the tray;

FIG. 6 is a flowchart illustrating an ejecting operation;

FIG. 7 is a diagram illustrating the change of voltage applied to a dc motor during the ejecting operation of the optical disk apparatus;

FIGS. 8A to 8C are diagrams illustrating the change of voltage applied to a dc motor during an ejecting operation of an optical disk apparatus in accordance with other embodiments of the invention; and

FIG. 9 is a diagram illustrating the change of voltage applied to a dc motor during an ejecting operation of a conventional optical disk apparatus.

### DETAILED DESCRIPTION OF THE PREFFERED EMBODIMENTS

Hereafter, a description will be given of an optical disk apparatus to which an ejecting device in accordance with an embodiment of the invention is applied.

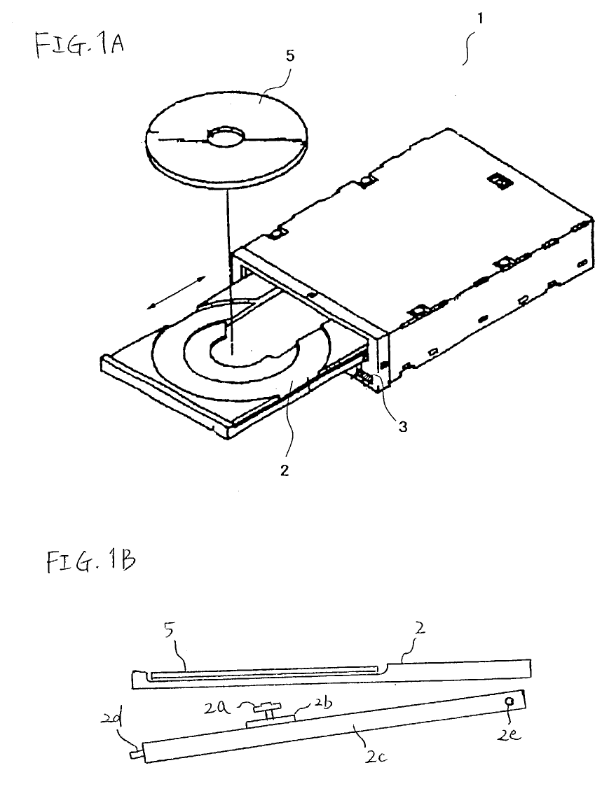

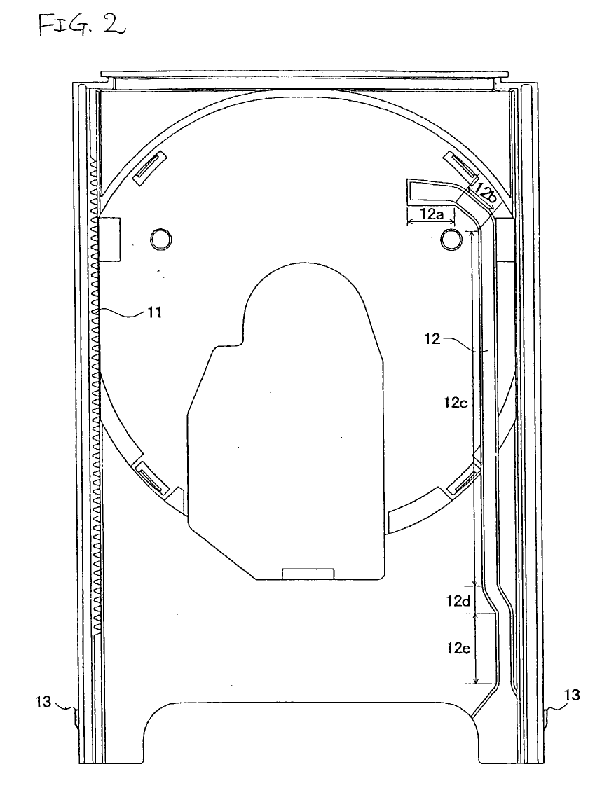

FIG. 1A is a schematic diagram of the optical disk apparatus. FIG. 1B is a schematic side view of a mechanism for raising a turntable in the optical disk apparatus. In the drawings, reference numeral 1 denotes a main body of the optical disk apparatus, and reference numeral 2 denotes a tray for mounting an optical disk 5 thereon. The tray 2 is installed so as to be movable in the directions of arrows in FIG. 1A. When the tray 2 is in a set position (not shown) in which it is accommodated in the main body 1, the optical disk 5 mounted on the tray 2 is held (chucked) onto a turntable 2a, and the optical disk 5 is rotated as the turntable 2a is rotated by a spindle motor 2b. The main body 1 of the optical disk apparatus thereby reads data recorded on the optical disk 5. At the time of reading the data (chucking), the turntable 2a is raised to set the optical disk 5 in a state of being lifted off the tray 2. In addition, reference numeral 3 shown in FIG. 1A denotes an ejection switch.

FIG. 2 is a diagram illustrating a reverse surface (the surface opposite to the surface where the optical disk 5 is mounted) of the tray. On the left side of FIG. 2, a rack gear 11 is formed along the moving direction (side surface) of the tray 2. Meanwhile, a restricting groove 12 for restricting the movement of the tray 2 is formed on the right side. As shown in FIG. 2, the restricting groove 12 includes a first groove 12a substantially parallel to the front surface (the upper side in the drawing) of the tray 2, a second groove 12b continuing from the first groove 12a and curved toward an outer side and a rear side of the tray 2, a third groove 12c continuing from the second groove 12b and extending along a side surface of the tray 2, a fourth groove 12c continuing from the third groove 12c and inclined toward the outer side of the tray 2, and a fifth groove 12e continuing from the fourth groove 12d and extending along the side surface of the tray 2. In addition, a pair of projections 13 are respectively provided at rear ends on both side surfaces of the tray 2.

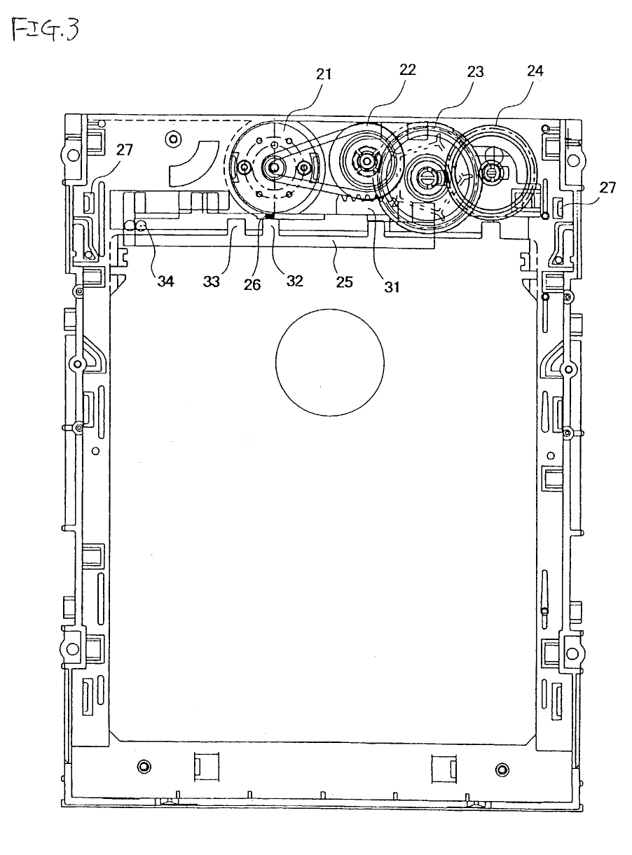

FIG. 3 is a plan view illustrating the interior of the main body of the optical disk apparatus. The turntable and the tray 2 are disposed on the surface shown in FIG. 3. In FIG. 3, reference numeral 21 denotes a dc motor which serves as a power source for moving the tray 2 between the set position and the eject position. The torque of the dc motor 21 is transmitted to a first gear 22. Numeral 23 denotes a second gear, and the torque of the dc motor 21 is transmitted thereto through the first gear 22. Further, numeral 24 denotes a third gear, and the torque of the dc motor 21 is transmitted thereto through the first gear 22 and the second gear 23. The third gear 24 is disposed at a position where it meshes with the rack gear 11 provided on the tray 2 located above the third gear 24.

It should be noted that the rack gear 11 and the third gear 24 are not always in a meshing state, and are in a nonmeshing state when the tray 2 is in the set position. When the tray 2 is slightly ejected from the set position, the rack gear 11 and the third gear 24 mesh with each other.

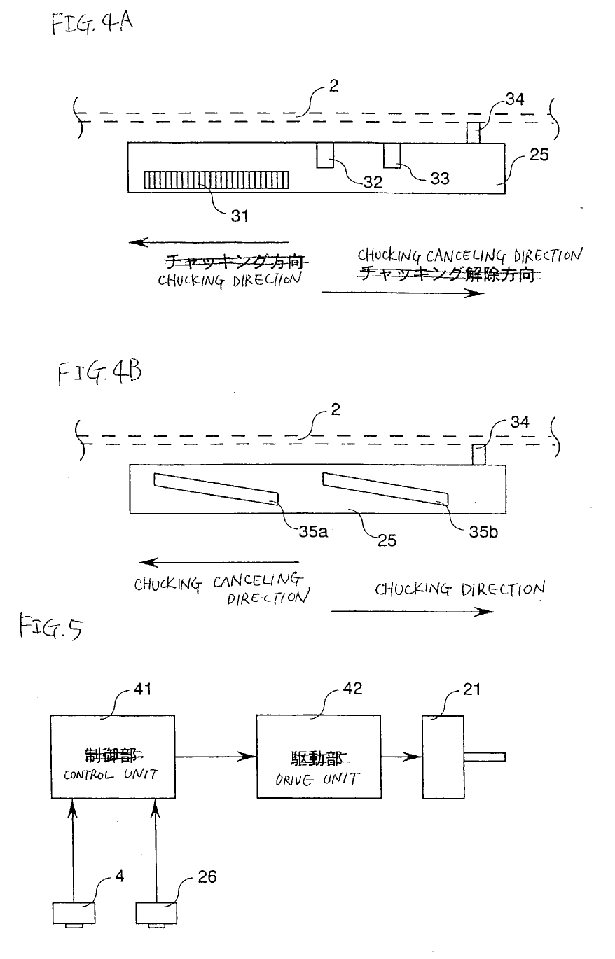

In addition, numeral 25 shown in FIG. 3 denotes a chucking canceling member (hereafter simply referred to as the canceling member 25) which is attached so as to be movable in the widthwise direction of the main body. FIG. 4A is a front elevational view of the canceling member, and FIG. 4B is a rear view of the canceling member. A swinging member 2c (see FIG. 1B) for raising the turntable 2a is engaged with this canceling member 25. Formed on the front of the canceling member 25 are a rack gear 31 meshing with the first gear 22, two projecting portions 32 and 33 for turning on a detection switch 26 provided on the main body, and a fitting portion 34 which is fitted and inserted in the restricting groove 12 provided in the tray 2 located above the canceling member 25.

In addition, a pair of openings 35a and 35b, into which pawls 2d provided on a front end portion of the swinging member 2c are inserted, are formed in a back face of the canceling member 25. The swinging member 2c is installed so as to be vertically movable with its support shaft 2e disposed in the rear end portion thereof (the side away from the side for fixation to the canceling member 25) serving as a fulcrum. When the canceling member 25 is moved in the leftward direction in FIG. 4A, the pawls 2d provided on the front end portion of the swinging member 2c are raised along the openings 35a and 35b, so that the turntable 2a is raised with the support shaft 2e serving as the fulcrum. On the other hand, when the canceling member 25 is moved in the rightward direction, the pawls 2d provided on the front end portion of the swinging member 2c are lowered along the openings 35a and 35b, so that the turntable 2a is lowered with the support shaft 2e serving as the fulcrum. The canceling member 25 is moved in the leftward direction during chucking, and is moved in the rightward direction during the cancellation of chucking.

A projecting portion, which fits in a central hole of the optical disk 5 mounted on the tray 2 when the canceling member 25 is moved leftward in FIG. 4A, is formed on the turntable 2a. When the canceling member 25 is moved leftward, and the turntable is thereby raised with its rear end portion serving as the fulcrum, the aforementioned projecting portion is fitted in the central hole of the optical disk 5, and the optical disk 5 is lifted off the tray 2.

A disk damper attached to a chucking plate is disposed above the turntable. The disk damper is formed of a magnet. The turntable is formed of either iron or a magnet. As the turntable is raised, the turntable and the disk damper are attracted to each other with the optical disk 5 clamped therebetween, so that the optical disk 5 is set in a chucked state. At this time, the optical disk 5 is in a state of being lifted off the tray 2. The turntable is attached to a rotating shaft of the spindle motor, and is rotated by the spindle motor. As the turntable is rotated, the chucked optical disk 5 is rotated.

Chucking is canceled when the canceling member 25 in this chucked state is moved rightward in FIG. 4A and the turntable is thereby lowered with its rear end portion serving as the fulcrum. At this time, since the turntable and the disk clamper are attracted to each other by a magnetic force, the canceling member 25 is moved rightward against the attracting force (the turntable and the disk damper are separated), so that a relatively large driving force is required. As the turntable is lowered, the optical disk 5 returns to the state in which it is mounted on the tray 2.

It should be noted that the rack gear 31 and the first gear 22 are not always in a meshing state, but they are in the meshing state when the fitting portion 34 is located in the first groove 12a or the second groove 12b, and is in a nonmeshing state when the fitting portion 34 is in the other positions. In addition, when the rack gear 31 and the first gear 22 are in the meshing state, the rack gear 11 and the third gear 24 are in a nonmeshing state. When the meshing state of the rack gear 31 and the first gear 22 is canceled, the rack gear 11 and the third gear 24 are changed over to the meshing state. On the other hand, when the rack gear 11 and the third gear 24 are changed over from the meshing state to the nonmeshing state, the rack gear 31 and the first gear 22 are changed over to the meshing state.

A pair of stoppers 27 shown in FIG. 3 are respectively provided at positions where the projections 13 provided on both side surfaces of the tray 2 abut.

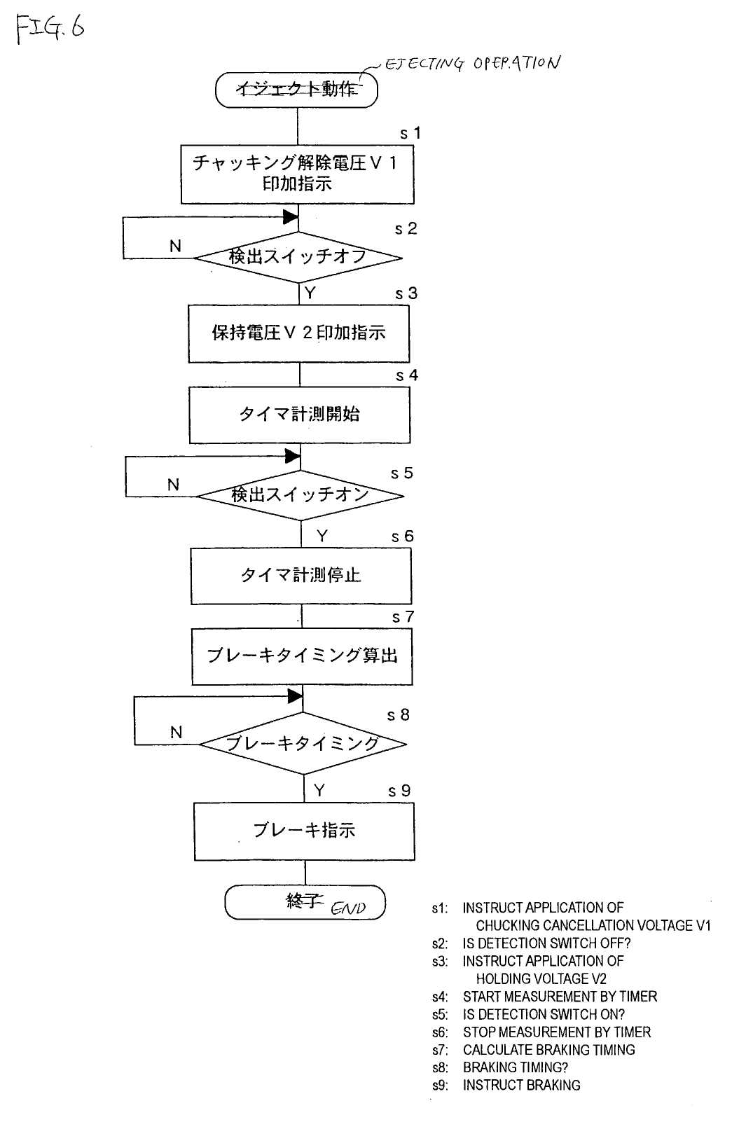

Next, a description will be given of a configuration for controlling the movement of the tray 2 between the set position and the eject position. FIG. 5 is a diagram illustrating the configuration of a movement controlling mechanism for controlling this movement. A control unit 41 controls the operation of the main body 1 of the optical disk apparatus. In addition, the control unit 41 instructs to a drive unit 42 a voltage to be applied to the dc motor 21. The drive unit 42 applies the instructed voltage to the dc motor 21 in accordance with the instruction from the control unit 41. Further, the states of the ejection switch 3 and the detection switch 26 which are provided on the main body are input to the control unit 41.

Hereafter, a description will be given of the ejecting operation which is effected when the ejection switch 3 is operated in state where the tray 2 is in the set position.

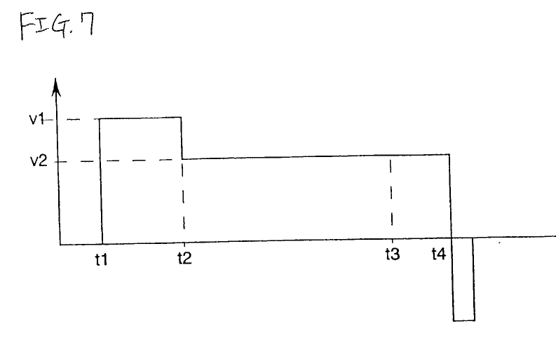

FIG. 6 is a flowchart illustrating the ejecting operation. Further, FIG. 7 is a diagram illustrating the change of the voltage applied to the dc motor 21. When the tray 2 is in the set position, the fitting portion 34 is in contact with the end portion of the first groove 12a. At this time, the turntable and the disk damper are in the chucking state in which they are attracted to each other with the optical disk clamped therebetween. In addition, the first gear 22 and the rack gear 31 are in the meshing state, while the third gear 24 and the rack gear 11 of the tray 2 are in the nonmeshing state. Further, the detection switch 26 is pressed by the projecting portion 33 and is on.

As the ejection switch 3 is operated, the control unit 41 starts the ejecting operation shown in FIG. 6. The control unit 41 instructs to the drive unit 42 the application of a chucking cancellation voltage v1 to the dc motor 21 (step s1). In response to this instruction, the drive unit 42 applies the chucking cancellation voltage v1 to the dc motor 21 (timing t1 shown in FIG. 7). This chucking cancellation voltage v1 is a predetermined voltage. The dc motor 21, upon application of the chucking cancellation voltage v1 thereto, generates a torque, and the canceling member 25 is moved leftward in FIG. 3 by this torque.

In conjunction with the movement of the canceling member 25, the position of the pawls of the turntable fitted and inserted in the openings 35a and 35b of the canceling member 25 is lowered, so that the turntable is lowered with its rear end portion serving as the fulcrum. Consequently, the turntable and the disk damper which are attracted to each other with the optical disk 5 clamped therebetween are separated. When the fitting portion 34 shifts from the first groove 12a to the second groove 12b, the chucking state is canceled. At this point of time, the first gear 22 and the rack gear 31 are in the meshing state, while the third gear 24 and the rack gear 11 of the tray 2 are in the nonmeshing state. Meanwhile, the pressing of the detection switch 26 by the projecting portion 33 is canceled, so that the detection switch 26 is changed over from on to off.

Upon detecting the changeover of the detection switch 26 from on to off (step s2), the control unit 41 instructs to the drive unit 42 the application of a holding voltage v2 to the dc motor 21 (step s3). In response to this instruction, the drive unit 42 changes over the voltage to be applied to the dc motor 21 from the chucking cancellation voltage v1 to the holding voltage v2 (timing t2 shown in FIG. 7). In addition, the control unit 41 starts the measurement of time by a timer (step s4).

The holding voltage v2 is a voltage lower than the chucking cancellation voltage v1. Also, the holding voltage v2 is a predetermined voltage. The chucking cancellation voltage v1 is a relatively high voltage for separating the turntable and the disk damper which are attracted to each other by the magnetic force.

The canceling member 25 is moved further leftward. At this time, since the fitting portion 34 is located in the second groove 12b, the tray 2 is pushed out toward the eject position. When the position of the fitting portion 34 reaches the connecting portion between the second groove 12b and the third groove 12c, the first gear 22 and the rack gear 31 are changed over from the meshing state to the nonmeshing state, whereas the third gear 24 and the rack gear 11 of the tray 2 are changed over from the nonmeshing state to the meshing state. At this time, the detection switch 26 is in the off state. The projecting portion 32 is located on the left side of the detection switch 26, while the projecting portion 33 is located on the right side of the detection switch 26.

As a result of the fact that the third gear 24 and the rack gear 11 of the tray 2 are set in the meshing state, the tray 2 is sent out toward the eject position by the torque of the dc motor 21.

The canceling member 25 does not move in the widthwise direction of the main body until the position of the fitting portion 34 reaches the connecting portion between the third groove 12c and the fourth groove 12d. When the position of the fitting portion 34 reaches the connecting portion between the third groove 12c and the fourth groove 12d, and moves from here to the connecting portion between the fourth groove 12d and the fifth groove 12e, the canceling member 25 is moved in the widthwise direction (toward the left side) of the main body. In conjunction with the movement of this canceling member 25, the projecting portion 32 presses the detection switch 26, so that the detection switch 26 is changed over from off to on.

Upon detecting the changeover of the detection switch 26 from off to on (step s5), the control unit 41 stops the timer which started the measurement of time in step s4 (step s6; timing t3 shown in FIG. 7), and calculates a timing for applying a brake to the dc motor 21 to stop the movement of the tray 2 (step s7).

In step s7, the time in which the time T (the time between t2 and t3) measured by the timer is multiplied by a predetermined coefficient a is calculated as the timing for applying the brake.

The amount of movement by which the try 2 moves in the ejecting direction from the time the detection switch 26 is turned off until it is turned on again is always fixed. Accordingly, in a case where the load at the time of the movement of the tray 2 is large, the aforementioned time T measured by the timer becomes long. On the other hand, in a case where the load at the time of the movement of the tray 2 is small, the time T measured by the timer becomes short. The time T measured by the timer is substantially inversely proportional to the load at the time of the movement of the tray 2. Accordingly, in step s7, the timing for applying the brake can be determined (calculated) in correspondence with the magnitude of the load of the tray 2. In other words, the brake can be applied at a timing when the tray 2 has been ejected by a fixed amount after the timing t3 shown in FIG. 7.

The control unit 41 applies the brake after waiting for the timing calculated in step s7 to be reached (steps s8 and s9).

Consequently, the tray 2 can be ejected from the main body only by an appropriate amount without being affected by the magnitude of the load at the time of the movement of the tray 2.

It should be noted that the holding voltage v2 is continued to be applied to the dc motor 21 during the period from the timing t3 till the timing t4. Further, the control unit 41 instructs the drive unit 42 to apply a reverse voltage to the dc motor 21 only for a fixed time duration (several milliseconds) in step s9.

Thus, the optical disk apparatus 1 of this embodiment is capable of ejecting the tray 2 from the main body only by an appropriate amount without being affected by the magnitude of the load at the time of the movement of the tray 2. Therefore, it is possible to prevent the situation in which the tray 2 fails to be ejected sufficiently, and the replacement of the optical disk 5 is therefore made troublesome. Meanwhile, the projections 13 of the tray 2 are prevented from colliding hard against the stoppers 27 provided on the main body, thereby making it possible to prevent the optical disk 5 or the main body from becoming damaged.

In addition, if the position where the tray 2 comes to a stop by applying the brake can be set short of the position where the projections 13 abut against the stoppers 27, an arrangement can be also provided so as to cause the projections 13 not to abut against the stoppers 27.

In addition, since the tray 2 can be ejected from the main body only by an appropriate amount without being affected by the deterioration of the dc motor 21 due to a change over time, it is possible to further improve the reliability of the main body of the apparatus.

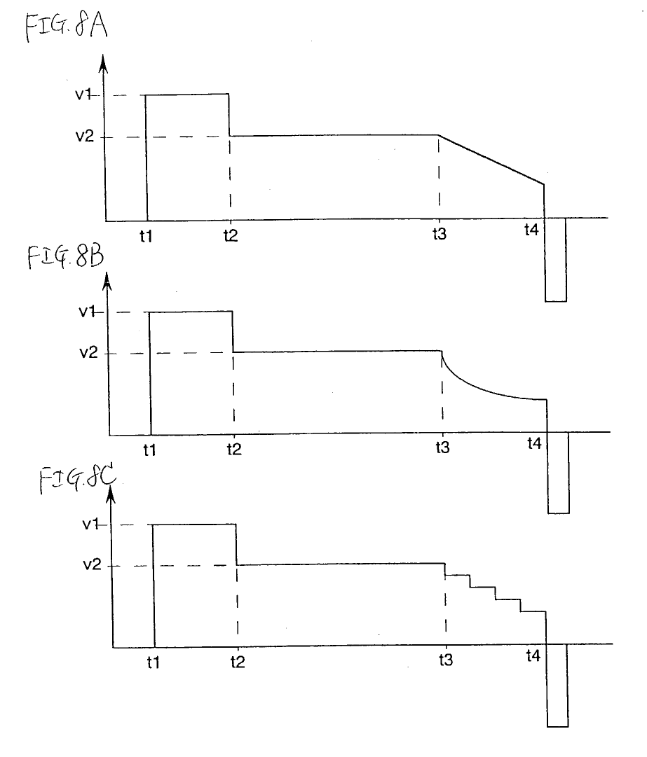

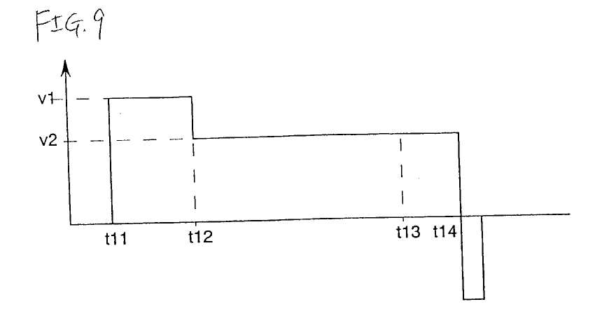

Although in the above-described embodiment the arrangement provided is such that the voltage applied to the dc motor 21 is maintained at the holding voltage v2 during the period from t3 till t4, the voltage applied to the dc motor 21 maybe lowered gradually. If such an arrangement is adopted, the impact applied to the tray 2 when the brake is applied can be suppressed further. For example, it suffices if the voltage applied to the dc motor 21 is lowered gradually during the period from t3 till t4, as shown in FIGS. 8A, 8B, and 8C. In this case, it suffices if the timing and the like for applying the brake are determined so that the area in the section between t3 and t4 becomes fixed.

Further, the holding voltage v2 during an ensuing ejection may be calculated on the basis of the time T between t2 and t3 measured by the timer. Specifically, by calculating the holding voltage v2 from the formula:

ensuing holding voltage v2=most recent holding voltage v2×measured time T/predetermined time T0

the time duration from the time the ejection switch 3 is operated until the ejection of the tray 2 is completed can be substantially fixed. Thus, it is possible to overcome the problem that the time involved in the ejecting operation becomes long in conjunction with the deterioration of the dc motor 21 due to a change over time. Consequently, it is possible to further improve the reliability of the main body of the apparatus.

As described above, in accordance with this invention, it is always possible to fix the amount of ejection of the tray during ejection without being affected by the magnitude of the load at the time of the movement of the tray. Accordingly, it is possible to prevent the situation in which the tray fails to be ejected sufficiently, and the replacement of the optical disk is therefore made troublesome. Meanwhile, the projections of the tray are prevented from colliding hard against the stoppers provided on the main body, thereby making it possible to prevent the optical disk or the main body from becoming damaged.

In addition, since the time involved in the ejecting operation can be fixed without being affected by the change over time of the main body of the apparatus, it is possible to further improve the reliability of the main body of the apparatus.

What is claimed is:

1. An ejecting device comprising:
a main body;
a tray on which a disk to be set in the main body is mounted;
a tray moving section for moving the tray between a set position for setting the disk in the main body and an eject position for ejecting the disk from the main body;
a detecting section for detecting that the tray is ejected from the main body by a predetermined amount during the movement of the tray from the set position to the eject position; and
a controlling section for determining a timing for applying a brake to the movement of the tray by the tray moving section on the basis of the time from the start of ejection of the tray until the ejection of the tray by the predetermined amount,
wherein the controlling section controls the magnitude of a force in a moving direction to be applied to the tray during the time from the start of ejection of the tray until the ejection of the tray by the predetermined amount at the time of an ensuing ejection of the tray, on the basis of the time required from the start of ejection of the tray until the ejection of the tray by the predetermined amount as well as the magnitude of a force in the moving direction applied to the tray when the tray is moved from the set position to the eject position.

2. An ejecting device comprising:
a main body;
a tray on which a disk to be set in the main body is mounted;
a tray moving section for moving the tray between a set position for setting the disk in the main body and an eject position for ejecting the disk from the main body;
a detecting section for detecting that the tray is ejected from the main body by a predetermined amount during the movement of the tray from the set position to the eject position; and
a controlling section for determining a timing for stopping the movement of the tray by the tray moving section on the basis of the time from the start of ejection of the tray until the ejection of the tray by the predetermined amount.

3. The ejecting device according to claim 2, wherein the controlling section determines a timing for applying a brake to the movement of the tray.

4. The ejecting device according to claim 3, wherein the controlling section gradually reduces a force in an ejecting direction to be applied to the tray during a period from the time the ejection of the tray by the predetermined amount is detected by the detecting section until the brake is applied to the movement of the tray.

5. The ejecting device according claim 2, wherein the controlling section controls the magnitude of a force in a moving direction to be applied to the tray during the time from the start of ejection of the tray until the ejection of the tray by the predetermined amount at the time of an ensuing ejection of the tray, on the basis of the time required from the start of ejection of the tray until the ejection of the tray by the predetermined amount as well as the magnitude of the force in the moving direction applied to the tray when the tray is moved from the set position to the eject position.
